(19) United States
(12) Patent Application Publication
(10) Pub. No.: US 2026/0095892 A1
(43) Pub. Date: Apr. 2, 2026

(54) PER-TUPLE NETWORK PAGING WHITELISTING

(71) Applicant: QUALCOMM Incorporated, San Diego, CA (US)

(72) Inventors: Soumya DAS, San Diego, CA (US); Mohammad NEKOUI, Escondido, CA (US); Mohsen BAHRAMI, Carlsbad, CA (US)

(21) Appl. No.: 18/901,682

(22) Filed: Sep. 30, 2024

(51) Int. Cl. H04W 68/02; H04W 8/22; H04W 76/10; H04W 76/20

(52) U.S. Cl. CPC H04W 68/02; H04W 8/22; H04W 76/10; H04W 76/20

(57) ABSTRACT

Various aspects of the present disclosure generally relate to wireless communication. Some aspects more specifically relate to network-side whitelisting of paging messages. In some aspects, a network may filter paging messages on a per-tuple basis using a network-side whitelist. For example, the network may permit or deny a packet destined for a vehicular user equipment (UE) depending on whether a tuple of the packet matches the whitelist.

### FIELD OF THE DISCLOSURE

Aspects of the present disclosure generally relate to wireless communication and specifically relate to techniques, apparatuses, and methods associated with per-tuple network paging whitelisting.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples.

A paging message can indicate that a user equipment (UE) is a target recipient for data. In some examples, the paging message may prompt the UE to transition from a low-power state to a high-power state and receive the data. For example, the UE may be a vehicular UE that enters the low-power state while a vehicle associated with the UE is parked. Upon receiving the paging message, a modem of the vehicular UE may relay the paging message to an application processor, which may identify whether to further process the paging message and/or perform a corresponding action. Consequently, the application processor may be woken up each time the modem receives a paging message, which may increase modem and/or central processing unit (CPU) workload or reduce UE battery life, among other examples. Multiple-universal-subscriber-identity-module (multi-USIM) UEs may have a page restriction functionality whereby a multi-USIM UE may declare, to an access and mobility management function (AMF), a preference for receiving various types of pages; however, the page restriction functionality operates on a low level of granularity—that is, per-protocol-data-unit-session. As a result, multi-USIM UEs that are capable of implementing the page restriction functionality may nonetheless receive unnecessary pages and, thus, consume excessive modem and/or CPU workload or battery power, among other examples. Moreover, the page restriction functionality is unavailable for single-USIM UEs and, thus, may not mitigate battery power loss or modem and/or CPU workload for single-USIM UEs.

### SUMMARY

Some aspects described herein relate to an apparatus for wireless communication at a user equipment (UE). The apparatus may include one or more memories storing processor-executable code and one or more processors coupled with the one or more memories. At least one processor of the one or more processors may be configured to cause the UE to transmit a request to establish a network session. At least one processor of the one or more processors may be configured to cause the UE to receive an indication of per-tuple network paging whitelisting information associated with the network session. At least one processor of the one or more processors may be configured to cause the UE to selectively receive a paging message in accordance with the per-tuple network paging whitelisting information.

Some aspects described herein relate to an apparatus for wireless communication at a network node. The apparatus may include one or more memories storing processor-executable code and one or more processors coupled with the one or more memories. At least one processor of the one or more processors may be configured to cause the network node to receive a request to establish a network session. At least one processor of the one or more processors may be configured to cause the network node to transmit an indication of per-tuple network paging whitelisting information associated with the network session. At least one processor of the one or more processors may be configured to cause the network node to selectively transmit a paging message in accordance with the per-tuple network paging whitelisting information.

Some aspects described herein relate to a method of wireless communication performed at a UE. The method may include transmitting a request to establish a network session. The method may include receiving an indication of per-tuple network paging whitelisting information associated with the network session. The method may include selectively receiving a paging message in accordance with the per-tuple network paging whitelisting information.

Some aspects described herein relate to a method of wireless communication performed at a network node. The method may include receiving a request to establish a network session. The method may include transmitting an indication of per-tuple network paging whitelisting information associated with the network session. The method may include selectively transmitting a paging message in accordance with the per-tuple network paging whitelisting information.

Some aspects described herein relate to an apparatus for wireless communication. The apparatus may include means for transmitting a request to establish a network session. The apparatus may include means for receiving an indication of per-tuple network paging whitelisting information associated with the network session. The apparatus may include means for selectively receiving a paging message in accordance with the per-tuple network paging whitelisting information.

Some aspects described herein relate to an apparatus for wireless communication. The apparatus may include means for receiving a request to establish a network session. The apparatus may include means for transmitting an indication of per-tuple network paging whitelisting information associated with the network session. The apparatus may include means for selectively transmitting a paging message in accordance with the per-tuple network paging whitelisting information.

Some aspects described herein relate to a non-transitory computer-readable medium storing a set of instructions for wireless communication. The set of instructions may include one or more instructions that, when executed at a UE, cause the UE to transmit a request to establish a network session. The set of instructions may include one or more instructions that, when executed at the UE, cause the UE to receive an indication of per-tuple network paging whitelisting information associated with the network session. The set of instructions may include one or more instructions that, when executed at the UE, cause the UE to selectively receive a paging message in accordance with the per-tuple network paging whitelisting information.

Some aspects described herein relate to a non-transitory computer-readable medium storing a set of instructions for wireless communication. The set of instructions may include one or more instructions that, when executed at a network node, cause the network node to receive a request to establish a network session. The set of instructions may include one or more instructions that, when executed at the network node, cause the network node to transmit an indication of per-tuple network paging whitelisting information associated with the network session. The set of instructions may include one or more instructions that, when executed at the network node, cause the network node to selectively transmit a paging message in accordance with the per-tuple network paging whitelisting information.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network in accordance with the present disclosure.

FIG. 2 is a diagram illustrating an example associated with signaling for per-tuple network paging whitelisting, in accordance with the present disclosure.

FIG. 3 is a diagram illustrating an example associated with whitelists configured by a user equipment (UE), in accordance with the present disclosure.

FIGS. 4A and 4B are diagrams illustrating an example associated with network-side whitelists indicated via UE assistance information (UAI), in accordance with the present disclosure.

FIG. 5 is a diagram illustrating an example associated with a protocol data unit (PDU) session establishment or modification request message that includes per-tuple network paging whitelisting information, in accordance with the present disclosure.

FIG. 6 is a diagram illustrating an example associated with UE capability information indicating support for per-tuple network paging whitelisting, in accordance with the present disclosure.

FIG. 7 is a diagram illustrating an example associated with a per-tuple network paging whitelisting configuration, in accordance with the present disclosure.

FIG. 8 is a diagram illustrating examples associated with a per-tuple network paging whitelisting UAI, in accordance with the present disclosure.

FIG. 9 is a flowchart illustrating an example process performed, for example, at a UE or an apparatus of a UE that supports per-tuple network paging whitelisting in accordance with the present disclosure.

FIG. 10 is a flowchart illustrating an example process performed, for example, at a network node or an apparatus of a network node that supports per-tuple network paging whitelisting in accordance with the present disclosure.

FIG. 11 is a diagram of an example apparatus for wireless communication, such as a UE, that supports per-tuple network paging whitelisting in accordance with the present disclosure.

FIG. 12 is a diagram of an example apparatus for wireless communication, such as a network node, that supports per-tuple network paging whitelisting in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

While a vehicle is parked, a vehicular user equipment (UE) associated with the vehicle may enter a low-power state to conserve battery life. In the low-power state, a modem of the vehicular UE may enter an idle discontinuous reception (DRX) mode, in which the modem may attempt to detect potential incoming paging messages (for example, mobile-terminated (MT) messages) that can prompt the vehicular UE to transition from the low-power state to a high-power state and receive data. For example, the modem may temporarily transition to a radio resource control (RRC) connected mode and transmit, to a backend server, keepalive messages to maintain a network connection and/or enable remote wakeup.

In some examples, upon receiving a paging message, the modem may relay the paging message to an application processor, which may identify whether to further process the paging message and/or perform a corresponding action. Consequently, the application processor may be woken up each time the modem receives a paging message, which may increase modem and/or central processing unit (CPU) workload or reduce UE battery life, among other examples. Multiple-universal-subscriber-identity-module (multi-USIM) UEs may have a page restriction functionality whereby a multi-USIM UE may declare, to an access and mobility management function (AMF), a preference for receiving various types of pages. However, the page restriction functionality operates on a low level of granularity—that is, per-protocol-data-unit-session. As a result, multi-USIM UEs that are capable of implementing the page restriction functionality may nonetheless receive unnecessary pages and, thus, consume excessive modem and/or CPU workload or battery power, among other examples. Moreover, the page restriction functionality is unavailable for single-universal-subscriber-identity-module (single-USIM) UEs and, thus, may not mitigate battery power loss or modem and/or CPU workload for single-USIM UEs.

Various aspects relate generally to network-side whitelisting of paging messages. Some aspects more specifically relate to network-based paging whitelisting for vehicular UEs. In some aspects, a network may filter paging messages on a per-tuple basis using a network-side whitelist. For example, the network may permit or deny a packet destined for the vehicular UE depending on whether a tuple of the packet matches the whitelist (for example, whether every element of the tuple is identical to a network-side whitelist entry that includes corresponding elements).

In some aspects, the UE may prompt addition, modification, or removal of whitelisting information with respect to the network-side whitelist. For example, the UE may configure the network-side whitelist using a PDU session establishment or modification request. Additionally or alternatively, the UE may indicate the addition, modification, or removal of the whitelisting information using UE assistance information (UAI).

In some aspects, the backend server may configure the whitelist. For example, the backend server may prompt addition, modification, or removal of whitelisting information with respect to the network-side whitelist.

Particular aspects of the subject matter described in this disclosure can be implemented to realize one or more of the following potential advantages. In some examples, the described techniques can be used to suppress unnecessary paging of a UE, thereby substantially reducing modem or CPU workload and/or prolonging battery life. For example, modem or CPU workload and/or battery life may be improved for a vehicular UE in a parked state, a single-USIM UE, or a vehicular UE in a non-parked state and in a dual subscriber identity module (SIM), dual active (DSDA) mode, among other examples. Furthermore, the described techniques allow for granular (rather than per-PDU-session) paging restrictions. For example, the per-tuple network paging whitelisting information may enable packet filters for granular page whitelisting within a PDU session. For example, packet filters of the network-side whitelist may allow certain paging messages that originate from whitelisted internet protocol (IP) addresses of a PDU session, and deny paging messages that originate from non-whitelisted IP addresses of the same PDU session.

The UE configuring or providing information for the network-side whitelist may help to further conserve power at the UE. For example, the UE may configure the network-side whitelist according to a remaining battery life of the UE.

The backend server configuring the whitelist may help to improve a service (for example, an application) provided by the server for the UE. For example, the server may configure the network-side whitelist according to an importance of packets transmitted by the server.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

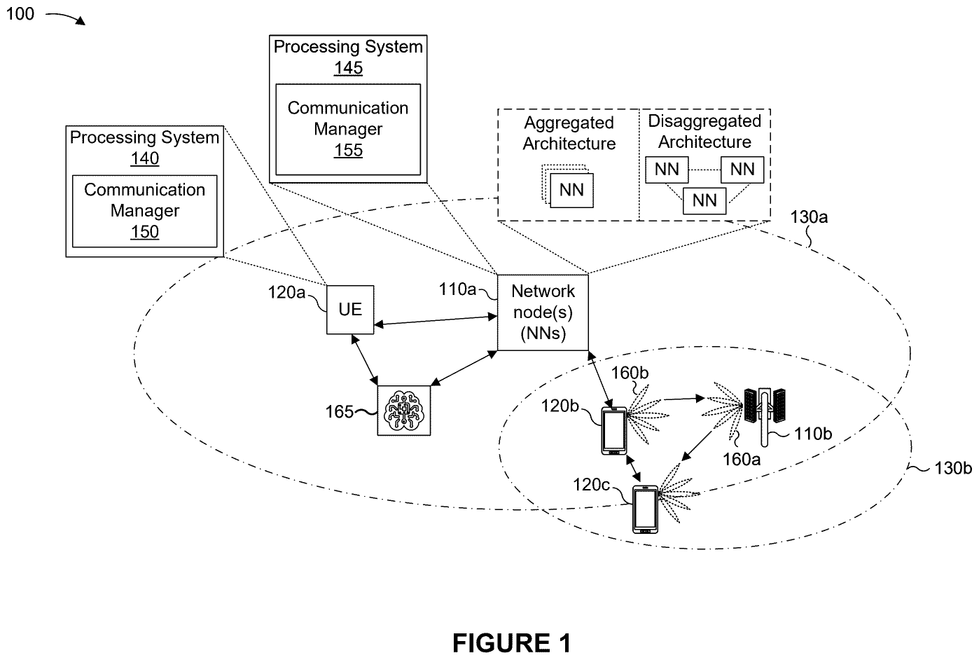

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHZ), FR2 (24.25 GHz through 52.6 GHZ), FR3 (7.125 GHz through 24.25 GHZ), FR4a or FR4-1 (52.6 GHz through 71 GHZ), FR4 (52.6 GHZ through 114.25 GHZ), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHZ,” if used herein, may broadly refer to frequencies that are less than 6 GHZ, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHZ.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as an RRC layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, smart jewelry, a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary synchronization signal (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot formal indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), a synchronization signal/PBCH (SS/PBCH) resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, a network node 110 and/or UEs 120). For example, the one or more devices 165 may include a UE 120 (for example, the processing system 140), a network node 110 (for example, the processing system 145), one or more servers, and/or one or more components of a cloud computing network, among other examples. In some examples, the AI/ML model (or an instance of the AI/ML model) may be deployed at multiple devices (for example, a first portion of the AI/ML model may be deployed at a UE 120 and a second portion of the AI/ML model may be deployed at a network node 110). In other examples, a first AI/ML model may be deployed at a UE 120 and a second AI/ML model may be deployed at a network node 110. The AI/ML model(s) may be configured to enhance various aspects of the wireless communication network 100. For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

In some aspects, the UE 120 may include a communication manager 150. As described in more detail elsewhere herein, the communication manager 150 may transmit a request to establish a network session; receive an indication of per-tuple network paging whitelisting information associated with the network session; and selectively receive a paging message in accordance with the per-tuple network paging whitelisting information. Additionally or alternatively, the communication manager 150 may perform one or more other operations described herein.

In some aspects, the network node 110 may include a communication manager 155. As described in more detail elsewhere herein, the communication manager 155 may receive a request to establish a network session; transmit an indication of per-tuple network paging whitelisting information associated with the network session; and selectively transmit a paging message in accordance with the per-tuple network paging whitelisting information. Additionally or alternatively, the communication manager 155 may perform one or more other operations described herein.

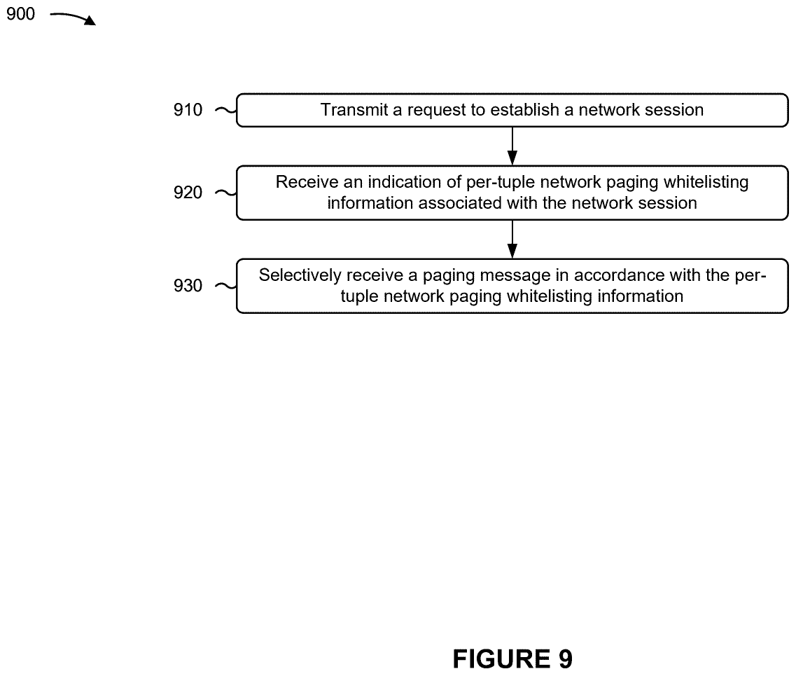

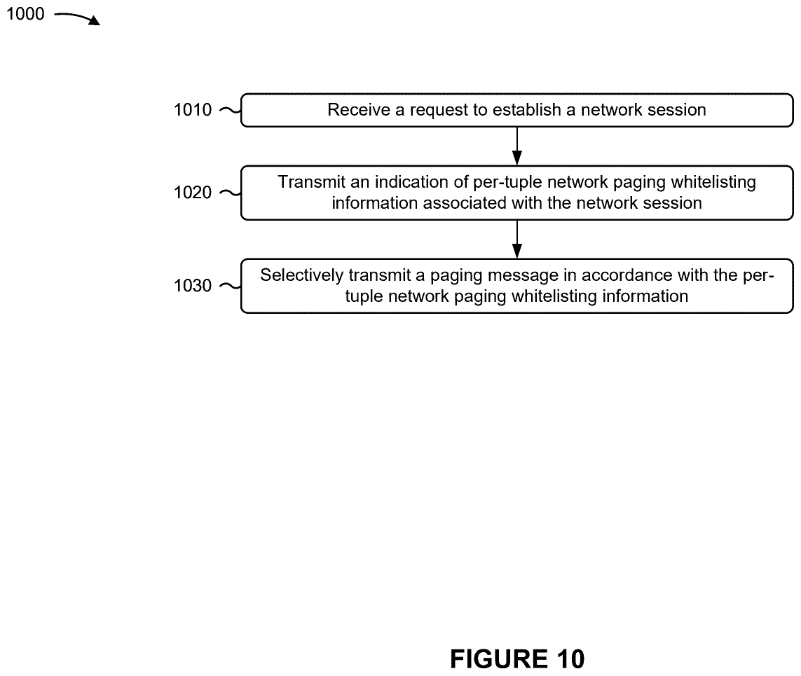

The network node 110, the processing system 145 of the network node 110, the UE 120, the processing system 140 of the UE 120, or any other component(s) of FIG. 1 may implement one or more techniques or perform one or more operations associated with per-tuple network paging whitelisting, as described in more detail elsewhere herein. For example, the processing system 145 of the network node 110, the processing system 140 of the UE 120 may perform or direct operations of, for example, process 900 of FIG. 9, process 1000 of FIG. 10, or other processes as described herein (alone or in conjunction with one or more other processors). Memory of the network node 110 may store data and program code (or instructions) for the network node 110. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110 or the UE 120, may cause the one or more processors to perform process 900 of FIG. 9, process 1000 of FIG. 10, or other processes as described herein. In some examples, executing instructions may include running the instructions, converting the instructions, compiling the instructions, and/or interpreting the instructions, among other examples.

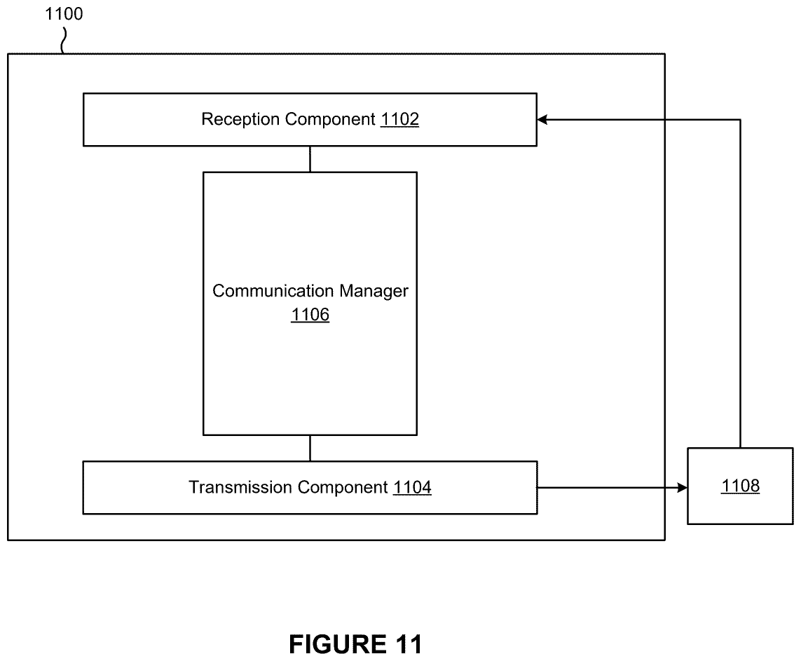

In some aspects, the UE 120 includes means for transmitting a request to establish a network session; means for receiving an indication of per-tuple network paging whitelisting information associated with the network session; and/or means for selectively receiving a paging message in accordance with the per-tuple network paging whitelisting information. The means for the UE 120 to perform operations described herein may include, for example, one or more of communication manager 150, processing system 140, a radio, one or more RF chains, one or more transceivers, one or more antennas, one or more modems, a reception component (for example, reception component 1102 depicted and described in connection with FIG. 11), and/or a transmission component (for example, transmission component 1104 depicted and described in connection with FIG. 11), among other examples.

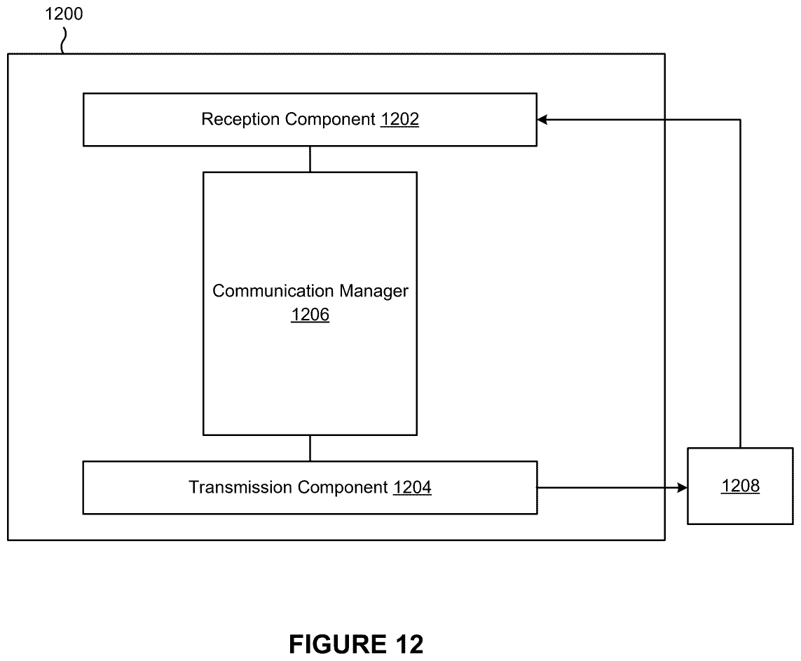

In some aspects, the network node 110 includes means for receiving a request to establish a network session; means for transmitting an indication of per-tuple network paging whitelisting information associated with the network session; and/or means for selectively transmitting a paging message in accordance with the per-tuple network paging whitelisting information. The means for the network node 110 to perform operations described herein may include, for example, one or more of communication manager 155, processing system 145, a radio, one or more RF chains, one or more transceivers, one or more antennas, one or more modems, a reception component (for example, reception component 1202 depicted and described in connection with FIG. 12), and/or a transmission component (for example, transmission component 1204 depicted and described in connection with FIG. 12), among other examples.

While a vehicle is parked, a vehicular UE (for example, a network access device (NAD)) associated with the vehicle may enter a low-power state to conserve battery life. In the low-power state, a modem of the vehicular UE may perform idle DRX, an application processor of the vehicular UE may be suspended, or NAD interfaces may be shut off, among other examples. The modem performing idle DRX may attempt to detect potential pages indicating incoming calls or a short message service (SMS) message, among other examples. In some examples, the modem may temporarily transition to an RRC connected mode and transmit, to an original equipment manufacturer (OEM) backend server, transmission control protocol (TCP) keepalive messages to maintain a TCP connection and enable remote wakeup.

In some examples, upon receiving a page or remote wakeup message (for example, an MT message), the modem may relay the page or remote wakeup message to the application processor. The application processor may identify whether to further process the MT message and perform a corresponding action. Consequently, the application processor may be woken up each time the modem receives a page or remote wakeup message, which may lead to numerous application processor wakeups and, thus, increased modem and/or CPU workload, or reduced battery life, among other examples.

Multi-USIM UEs may have a page restriction functionality. For example, a multi-USIM UE may declare, to an AMF, a preference for receiving various types of pages on a PDU-session-level granularity. The page restriction functionality may help to reduce data transfer interruptions on a connected SIM while tuning to receive pages on another SIM (for example, while the multi-USIM UE is operating in a dual SIM, dual standby (DSDS) mode). However, the page restriction functionality operates on a low level of granularity—that is, per-PDU-session. As a result, multi-SIM UEs that are capable of implementing the page restriction functionality may nonetheless receive unnecessary pages and, thus, consume excessive modem and/or CPU workload or battery power, among other examples. For example, a multi-SIM UE may receive all pages of a PDU session, regardless of the IP address of the server that prompted the page. Moreover, the page restriction functionality is unavailable for single-USIM UEs and, thus, may not mitigate battery power loss or modem and/or CPU workload for single-USIM UEs.

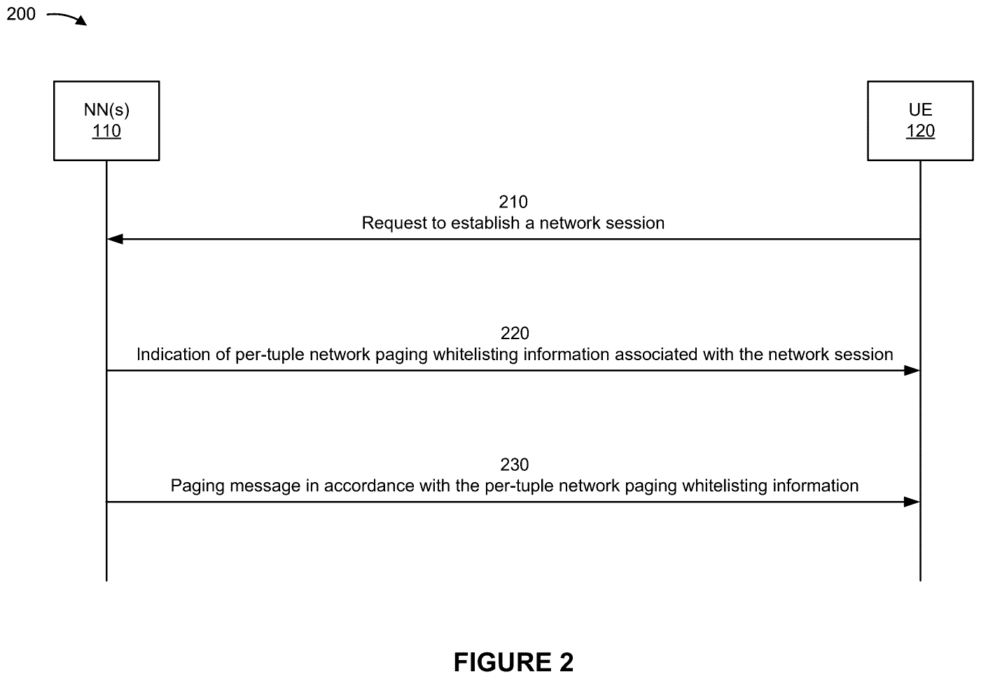

FIG. 2 is a diagram illustrating an example 200 associated with signaling for per-tuple network paging whitelisting, in accordance with the present disclosure. As shown in FIG. 2, a network node 110 and a UE 120 (for example, a vehicular UE) may communicate with one another.

In a first operation 210, the UE 120 may transmit, and the network node 110 may receive, a request to establish a network session. For example, the network session may be a protocol data unit (PDU) session, and the request may be a PDU session establishment request.

In a second operation 220, the network node 110 may transmit, and the UE 120 may receive, an indication of per-tuple network paging whitelisting information associated with the network session. A tuple may include packet-specific information. In some examples, the per-tuple network paging information may indicate which pages are to be whitelisted on a per-tuple basis. For example, the per-tuple network paging whitelisting information may indicate a configuration of a network-side whitelist that a core network entity (for example, a session management function (SMF)) can use to filter pages. In some examples, the per-tuple network paging whitelisting information may be associated with the network session in that the per-tuple network paging whitelisting information may apply to the network session. For example, different network sessions may be associated with respective per-tuple network paging information. In some examples, the indication of the per-tuple network paging information may be carried in a PDU session establishment accept message or an RRC reconfiguration message, among other examples.

In some aspects, the per-tuple network paging whitelisting information may include one or more of a filter identifier, a packet filter, an allowed page type, or an allowed packet type. For example, the network-side whitelist may comprise a tuple (for example, a triplet) that includes one or more of the filter ID, the packet filter, and/or allowed pages or packets. The filter identifier may identify the packet filter, and the packet filter may include the tuple, such as an IP tuple. The allowed page type may be a type of page that is whitelisted. For example, the allowed page type may be SMS messages or a voice service, such as IP multimedia subsystem (IMS) voice, among other examples. The allowed packet type may be a type of packet that is whitelisted. For example, the allowed packet type may be TCP PUSCH packets (for example, for remote wakeup).

In some aspects, the packet filter may include one or more of a source IP address, a destination IP address, a source port, a destination port, or a protocol. For example, packets in the network session that indicate the source IP address, the destination IP address, the source port, the destination port, and the protocol may be whitelisted.

In a third operation 230, the network node 110 may selectively transmit, and the UE 120 may selectively receive, a paging message (for example, a page) in accordance with the per-tuple network paging whitelisting information. For example, the network node 110 may selectively transmit, and the UE 120 may selectively receive, the paging message responsive to the paging message matching the per-tuple network paging whitelisting information. For example, if a tuple of the paging message matches the per-tuple network paging whitelisting information of the network-based whitelist, then the core network entity may transmit the paging message to the network node 110, and the network node 110 may transmit, and the UE 120 may receive, the paging message. In some examples, the network node 110 may transmit the paging message over an access (Uu) link. If the tuple of the paging message does not match the per-tuple network paging whitelisting information of the network-based whitelist, then the core network entity may refrain from transmitting the paging message to the network node 110, and the network node 110 may refrain from transmitting the paging message.

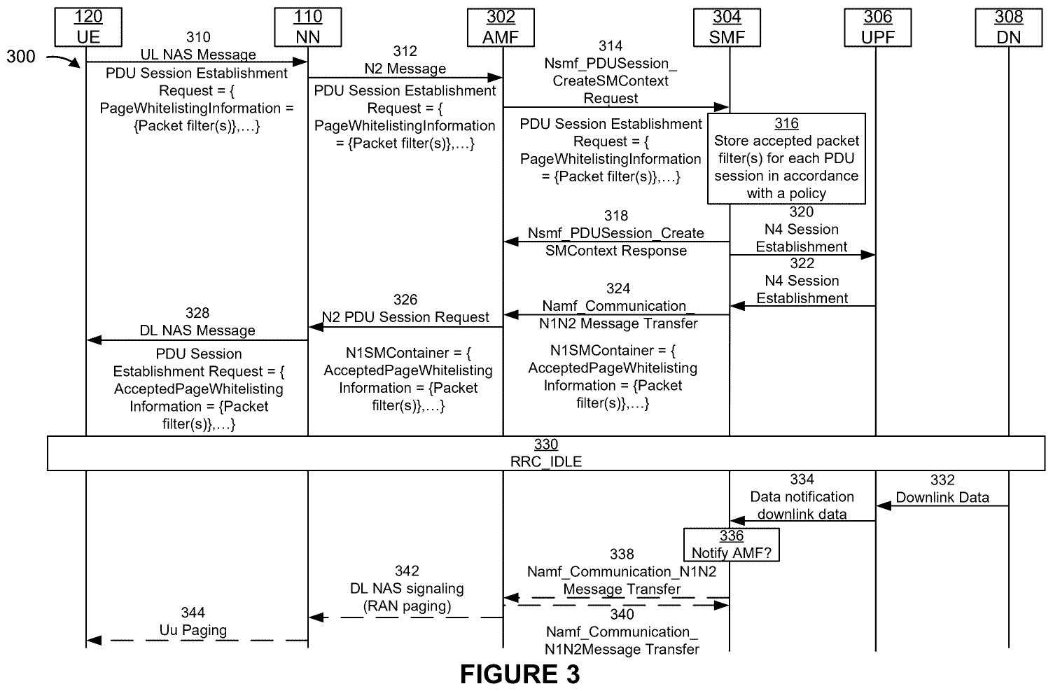

FIG. 3 is a diagram illustrating an example 300 associated with UE-configured whitelists, in accordance with the present disclosure. As shown in FIG. 3, a UE 120 (for example, a vehicular UE), a network node 110, and various core network entities may communicate with one another. The core network entities may include an AMF 302, an SMF 304, a user plane function (UPF) 306, and a data network (DN) 308.

In a first operation 310, the UE 120 may transmit, and the network node 110 may receive, a request to establish a network session (for example, a PDU session). For example, the request to establish the network session may be a PDU session establishment request carried in an uplink non-access stratum (NAS) message.

In some aspects, the request to establish the network session may include the per-tuple network paging whitelisting information. For example, the UE 120 may identify the per-tuple network paging whitelisting information and configure the network-side whitelist associated with the network session using the request to establish the network session.

In some aspects, the per-tuple network paging whitelisting information may include a whitelisted IP address. The whitelisted IP address may be an IP address of a backend server that is being whitelisted. For example, the whitelisted IP address may be a source IP address of paging messages prompted by the backend server. The UE 120 may identify the whitelisted IP address and indicate the whitelisted IP address in the request to establish the network session for inclusion in a packet filter. In some examples, the UE 120 may not identify an IP address of the UE 120 (for example, a destination IP address of paging messages prompted by the backend server) before the network session has been established.

Additionally or alternatively, in some aspects, the UE 120 may transmit, and the network node 110 may receive, a network session modification message that includes updated per-tuple network paging whitelisting information. The network session modification message (for example, a PDU session modification message) may request to modify an established network session. For example, the UE 120 may add, modify, or remove one or more packet filters associated with a network-side whitelist after the network session has been established. For example, the UE 120 may dynamically modify the network-side whitelist according to a vehicle state of the UE 120 (for example, the UE 120 may adjust the network-side whitelist in accordance with whether a vehicle associated with the UE 120 is parked at an airport in long-term parking or short-term parking). In some examples, filter identifiers that were present in the request to establish the network session may be excluded from the network session modification message to remove corresponding packet filters from the network-side whitelist. Additionally or alternatively, filter identifiers that were present in the request to establish the network session may be included in the network session modification message to reinstate or modify corresponding packet filters in the network-side whitelist. Additionally or alternatively, filter identifiers that were absent from the request to establish the network session may be included in the network session modification message to add corresponding whitelist packet filters to the network-side whitelist.

In a second operation 312, the network node 110 may transmit, and the AMF 302 may receive, a network session establishment request. For example, the network session establishment request may be a PDU session establishment request. The network node 110 may transmit the network session establishment request in response to receiving the request to establish the network session. Additionally or alternatively, the network node 110 may transmit, and the AMF 302 may receive, a network session modification request. For example, the network session modification request may request to modify an established network session. The network session establishment or modification request may be carried over an N2 interface.

In some aspects, the network session establishment or modification request may include the per-tuple network paging whitelisting information. For example, the network node 110 may transmit the per-tuple network paging whitelisting information to the core network using the network session establishment or modification request.

In a third operation 314, the AMF 302 may transmit, and the SMF 304 may receive, a request to create session management context for the network session (for example, the PDU session). The request to create the session management context may include the per-tuple network paging whitelisting information. Thus, the per-tuple network paging whitelisting information may be conveyed by the UE 120 to the SMF 304 via the network node 110 and the AMF 302.

In a fourth operation 316, the SMF 304 may accept or reject the per-tuple network paging whitelisting information (which may be carried in a page whitelisting request) in accordance with a policy (for example, an operator policy or a subscription policy from a unified data management (UDM) entity, among other examples). Additionally or alternatively, the SMF 304 may store the per-tuple network paging whitelisting information (for example, any accepted packet filters) for the associated network session(s).

In a fifth operation 318, the SMF 304 may transmit, and the AMF 302 may receive, a response to the request to create session management context. In a sixth operation 320, the SMF 304 may transmit, and the UPF 306 may receive, a session establishment request. In a seventh operation 322, the UPF 306 may transmit, and the SMF 304 may receive, a session establishment response. The session establishment request and the session establishment response may be carried over an N4 interface.

In an eighth operation 324, the SMF 304 may transmit, and the AMF 302 may receive, a message transfer indicating the per-tuple network paging whitelisting information. For example, the message transfer may indicate that the SMF 304 has accepted or approved the per-tuple network paging whitelisting information. For example, the message transfer may indicate that the SMF 304 has created or modified the network-side whitelist in accordance with the per-tuple network paging whitelisting information. For example, the message transfer may indicate that the SMF 304 has populated one or more information elements (IEs) of the packet filter(s) in accordance with the per-tuple network paging whitelisting information. In some examples, the message transfer may be a service-based AMF interface (for example, an Namf interface) communication that carries an N1N2 message transfer.

In a ninth operation 326, the AMF 302 may transmit, and the network node 110 may receive, a request indicating the per-tuple network paging whitelisting information. For example, the request may indicate that the SMF 304 has accepted the per-tuple network paging whitelisting information. In some examples, the request may be a network session request, such as a PDU session request. In some examples, the network session request may be carried over an N2 interface. The AMF 302 may transmit the request in response to receiving the request to create session management context.

In a tenth operation 328, the network node 110 may transmit, and the UE 120 may receive, an indication of the per-tuple network paging whitelisting information. For example, the indication of the per-tuple network paging whitelisting information may indicate that the SMF 304 has accepted the per-tuple network paging whitelisting information. Thus, the indication (for example, acknowledgment) that the per-tuple network paging whitelisting information has been accepted may be conveyed by the SMF 304 to the UE 120 via the AMF 302 and the network node 110. In some examples, the indication of the per-tuple network paging whitelisting information may be a PDU session establishment accept message carried in a downlink NAS message. Additionally or alternatively, the indication of the per-tuple network paging whitelisting information may be carried in a PDU session modification command or acknowledgement message (for example, a PDU session modify accept message).

In some examples, the message transfer (eighth operation 324), the request (ninth operation 326), and/or the indication (tenth operation 328) may include a field (for example, “AcceptedPageWhitelisting-Information”) that carries the per-tuple network paging whitelisting information that has been accepted by the SMF 304. This field may enable the SMF 304, the AMF 302, and/or the network node 110 to acknowledge the per-tuple network paging whitelisting information (for example, the approved page whitelists).

In an eleventh operation 330, the UE 120 may enter an RRC idle mode. In a twelfth operation 332, the DN 308 may transmit, and the UPF 306 may receive, downlink data (for example, a message). For example, the downlink data may originate from the backend server. In a thirteenth operation 334, the UPF 306 may forward the downlink data to the SMF 304 with a data notification.

In a fourteenth operation 336, the SMF 304 may use the network-side whitelist to identify when or whether to notify the AMF 302 to relay the downlink data toward the UE 120. For example, the SMF 304 may, upon receipt of the downlink data, identify whether information of a packet carrying the downlink data matches the per-tuple network paging whitelisting information stored in the network-side whitelist. For example, the SMF 304 may identify whether a tuple of the packet matches a packet filter of the network-side whitelist.

In a fifteenth operation 338, the SMF 304 may selectively transmit, and the AMF 302 may selectively receive, an indication to page the UE 120. For example, the SMF 304 may transmit, and the AMF 302 may receive, the indication to page the UE 120 if the packet carrying the downlink data matches the network-side whitelist. The SMF 304 may refrain from transmitting the indication to page the UE 120 if the packet carrying the downlink data does not match the network-side whitelist.

In a sixteenth operation 340, the AMF 302 may selectively transmit, and the SMF 304 may selectively receive, a response to the indication to page the UE 120. For example, the AMF 302 may transmit, and the SMF 304 may receive, the response to the indication to page the UE 120 if the packet carrying the downlink data matches the network-side whitelist. The AMF 302 may refrain from transmitting the response to the indication to page the UE 120 if the packet carrying the downlink data does not match the network-side whitelist.

In a seventeenth operation 342, the AMF 302 may selectively transmit, and the network node 110 may selectively receive, a RAN paging message. For example, the AMF 302 may transmit, and the network node 110 may receive, the RAN paging message if the packet carrying the downlink data matches the network-side whitelist. The AMF 302 may refrain from transmitting the RAN paging message if the packet carrying the downlink data does not match the network-side whitelist.

In an eighteenth operation 344, the network node 110 may selectively transmit, and the UE 120 may selectively receive, a paging message in accordance with the per-tuple network paging whitelisting information. For example, the network node 110 may transmit, and the UE 120 may receive, the paging message if the packet carrying the downlink data matches the network-side whitelist. The network node 110 may refrain from transmitting the RAN paging message if the packet carrying the downlink data does not match the network-side whitelist.

As noted, example 300 is associated with UE-configured network-side whitelists. In other examples, network-side whitelists may be configured by a server. For example, network-side whitelists may be configured remotely by an application server, an OEM server, or a backend server, among other examples. For example, the server may transmit (for example, push), and a network exposure function (NEF) may receive, the per-tuple network paging whitelisting information. The NEF may transmit, and the SMF may receive, the per-tuple network paging whitelisting information. Thus, for example, the NEF may be used to configure and/or update the packet filters at the SMF 304. Remaining operations in a server-configured network-side whitelist flow may resemble operations 316-342. For example, in an operation similar to the thirteenth operation 334, the SMF 304 may filter MT messages using the network-side whitelist configured by the server.

In some aspects, the network node 110 may receive the per-tuple network paging whitelisting information from the server. For example, in an operation similar to the ninth operation 326, the AMF 302 may transmit, and the network node 110 may receive, a request indicating the per-tuple network paging whitelisting information. Thus, the network node 110 may receive the per-tuple network paging whitelisting information from the server via the NEF, the SMF 304, and the AMF 302.

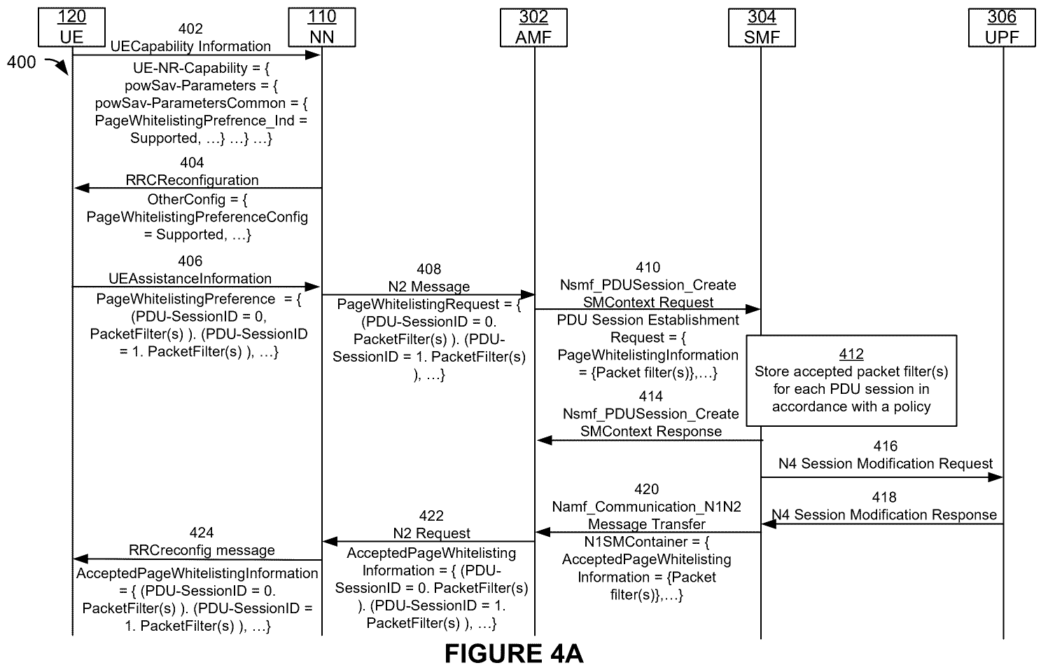

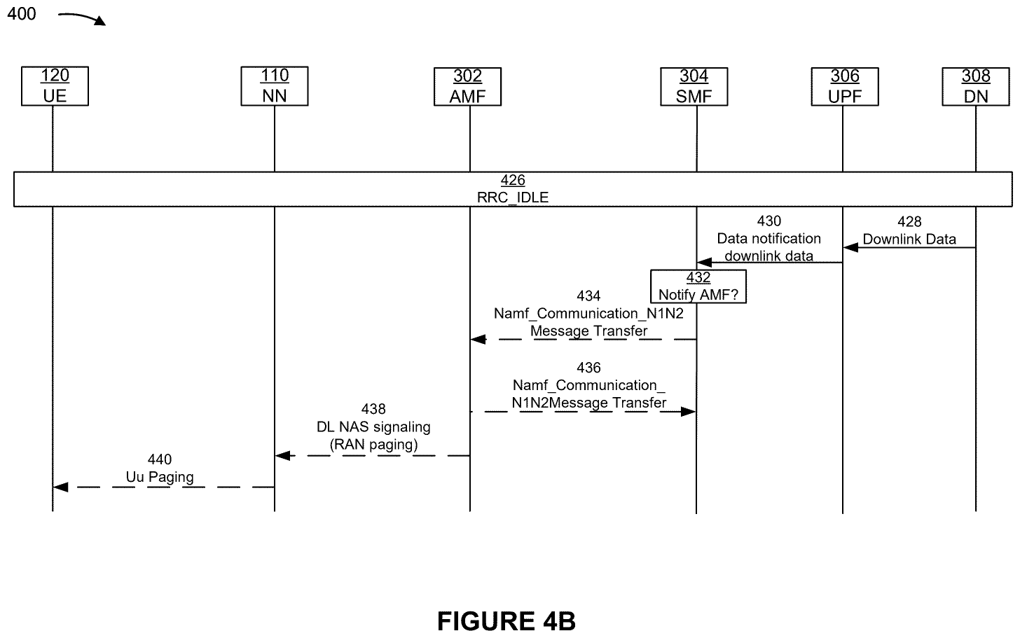

FIGS. 4A and 4B are diagrams illustrating an example 400 associated with UAI-based network-side whitelists, in accordance with the present disclosure. As shown in FIGS. 4A and 4B, a UE 120 (for example, a vehicular UE), a network node 110, and various core network entities may communicate with one another. The core network entities may include the AMF 302, the SMF 304, the UPF 306, and the DN 308.

With reference to FIG. 4A, in a first operation 402, the UE 120 may transmit, and the network node 110 may receive, UE capability information indicating support for per-tuple network paging whitelisting. For example, the UE capability information may indicate that the UE 120 is capable of selectively receiving paging messages in accordance with the per-tuple network paging whitelisting information. The UE 120 may transmit the UE capability information after a network session has been established.

In a second operation 404, the network node 110 may transmit, and the UE 120 may receive, a per-tuple network paging whitelisting configuration in accordance with the UE capability information. The per-tuple network paging whitelisting configuration may configure the UE 120 to selectively receive paging messages in accordance with the per-tuple network paging whitelisting information. The network node 110 may transmit the per-tuple network paging whitelisting configuration in response to the UE 120 indicating, in the UE capability information, that the UE 120 is capable of selectively receiving paging messages in accordance with the per-tuple network paging whitelisting information. In some examples, the per-tuple network paging whitelisting configuration may be carried in an RRC configuration (for example, an RRC reconfiguration).

In a third operation 406, the UE 120 may transmit, and the network node 110 may receive, UAI including the per-tuple network paging whitelisting information. For example, the UAI may indicate a preference associated with how the SMF 304 should perform the per-tuple network paging whitelisting. In some examples, the UE 120 may transmit the UAI while the UE 120 is in an RRC connected mode.

Additionally or alternatively, in some aspects, the UE 120 may transmit, and the network node 110 may receive, UAI including updated per-tuple network paging whitelisting information. The UAI including updated per-tuple network paging whitelisting information may modify an established network-side whitelist (for example, a network-side whitelist that was previously established using UAI or configured by a UE 120 or a server, as discussed above in connection with FIG. 3). For example, the UE 120 may add, modify, or remove one or more packet filters associated with a network-side whitelist. For example, the UE 120 may dynamically modify the network-side whitelist according to a vehicle state of the UE 120 (for example, the UE 120 may adjust the network-side whitelist in accordance with whether a vehicle associated with the UE 120 is parked at an airport in long-term parking or short-term parking). In some examples, previously indicated filter identifiers may not be included in the UAI including updated per-tuple network paging whitelisting information to remove corresponding packet filters from the network-side whitelist. Additionally or alternatively, previously indicated filter identifiers may be included in the UAI including updated per-tuple network paging whitelisting information to reinstate or modify corresponding packet filters in the network-side whitelist. Additionally or alternatively, filter identifiers that were not previously indicated may be included in the UAI including updated per-tuple network paging whitelisting information to add corresponding whitelist packet filters to the network-side whitelist.

In some aspects, the per-tuple network paging whitelisting information may include a whitelisted IP address. The whitelisted IP address may be an IP address of a backend server that is being whitelisted. For example, the whitelisted IP address may be a source IP address of paging messages prompted by the backend server. The UE 120 may identify the whitelisted IP address and indicate the whitelisted IP address in the request to establish the network session for inclusion in a packet filter. In some examples, the UE 120 may not identify an IP address of the UE 120 (for example, a destination IP address of paging messages prompted by the backend server) before the network session has been established.

In a fourth operation 408, the network node 110 may transmit, and the AMF 302 may receive, a request indicating the per-tuple network paging whitelisting information in accordance with the UAI. For example, the network node 110 may transmit the network session establishment request in response to receiving the UAI. In some examples, the request may be carried over an N2 interface (for example, the request may be an N2 message).

In a fifth operation 410, the AMF 302 may transmit, and the SMF 304 may receive, a request to update a session management context for a network session (for example, a PDU session). The request to update the session management context may include the per-tuple network paging whitelisting information. Thus, the per-tuple network paging whitelisting information may be conveyed by the UE 120 to the SMF 304 via the network node 110 and the AMF 302.

In a sixth operation 412, the SMF 304 may accept or reject the per-tuple network paging whitelisting information (which may be carried in a page whitelisting request) in accordance with a policy (for example, an operator policy or a subscription policy from a UDM entity, among other examples). Additionally or alternatively, the SMF 304 may store the per-tuple network paging whitelisting information (for example, any accepted packet filters) for the associated network session(s).

In a seventh operation 414, the SMF 304 may transmit, and the AMF 302 may receive, a response to the request to create the session management context. In an eighth operation 416, the SMF 304 may transmit, and the UPF 306 may receive, a session modification request. In a ninth operation 418, the UPF 306 may transmit, and the SMF 304 may receive, a session modification response. The session modification request and the session modification response may be carried over an N4 interface.

In a tenth operation 420, the SMF 304 may transmit, and the AMF 302 may receive, a message transfer indicating the per-tuple network paging whitelisting information. For example, the message transfer may indicate that the SMF 304 has accepted or approved the per-tuple network paging whitelisting information. For example, the message transfer may indicate that the SMF 304 has created or modified the network-side whitelist in accordance with the per-tuple network paging whitelisting information. For example, the message transfer may indicate that the SMF 304 has populated one or more IEs of the packet filter(s) in accordance with the per-tuple network paging whitelisting information.

In an eleventh operation 422, the AMF 302 may transmit, and the network node 110 may receive, a request indicating the per-tuple network paging whitelisting information. For example, the request may indicate that the SMF 304 has accepted the per-tuple network paging whitelisting information. In some examples, the request may be carried over an N2 interface (for example, the request may be an N2 request). The AMF 302 may transmit the request in response to receiving the request to create the session management context.

In a twelfth operation 424, the network node 110 may transmit, and the UE 120 may receive, an indication of the per-tuple network paging whitelisting information. For example, the indication of the per-tuple network paging whitelisting information may indicate that the SMF 304 has accepted the per-tuple network paging whitelisting information. Thus, the indication (for example, acknowledgment) that the per-tuple network paging whitelisting information has been accepted may be conveyed by the SMF 304 to the UE 120 via the AMF 302 and the network node 110. In some examples, the indication of the per-tuple network paging whitelisting information may be carried in an RRC configuration message (for example, an RRC reconfiguration message).

With reference to FIG. 4B, in a thirteenth operation 426, the UE 120 may enter an RRC idle mode. In a fourteenth operation 428, the DN 308 may transmit, and the UPF 306 may receive, downlink data (for example, a message). For example, the downlink data may originate from the backend server. In a fifteenth operation 430, the UPF 306 may forward the downlink data to the SMF 304 with a data notification.

In a sixteenth operation 432, the SMF 304 may use the network-side whitelist to identify when or whether to notify the AMF 302 to relay the downlink data toward the UE 120. For example, the SMF 304 may, upon receipt of the downlink data, identify whether information of a packet carrying the downlink data matches the per-tuple network paging whitelisting information stored in the network-side whitelist. For example, the SMF 304 may identify whether a tuple of the packet matches a packet filter of the network-side whitelist.

In a seventeenth operation 434, the SMF 304 may selectively transmit, and the AMF 302 may selectively receive, an indication to page the UE 120. For example, the SMF 304 may transmit, and the AMF 302 may receive, the indication to page the UE 120 if the packet carrying the downlink data matches the network-side whitelist. The SMF 304 may refrain from transmitting the indication to page the UE 120 if the packet carrying the downlink data does not match the network-side whitelist.

In an eighteenth operation 436, the AMF 302 may selectively transmit, and the SMF 304 may selectively receive, a response to the indication to page the UE 120. For example, the AMF 302 may transmit, and the SMF 304 may receive, the response to the indication to page the UE 120 if the packet carrying the downlink data matches the network-side whitelist. The AMF 302 may refrain from transmitting the response to the indication to page the UE 120 if the packet carrying the downlink data does not match the network-side whitelist.

In a nineteenth operation 438, the AMF 302 may selectively transmit, and the network node 110 may selectively receive, a RAN paging message. For example, the AMF 302 may transmit, and the network node 110 may receive, the RAN paging message if the packet carrying the downlink data matches the network-side whitelist. The AMF 302 may refrain from transmitting the RAN paging message if the packet carrying the downlink data does not match the network-side whitelist.

In a twentieth operation 440, the network node 110 may selectively transmit, and the UE 120 may selectively receive, a paging message in accordance with the per-tuple network paging whitelisting information. For example, the network node 110 may transmit, and the UE 120 may receive, the paging message if the packet carrying the downlink data matches the network-side whitelist. The network node 110 may refrain from transmitting the RAN paging message if the packet carrying the downlink data does not match the network-side whitelist.

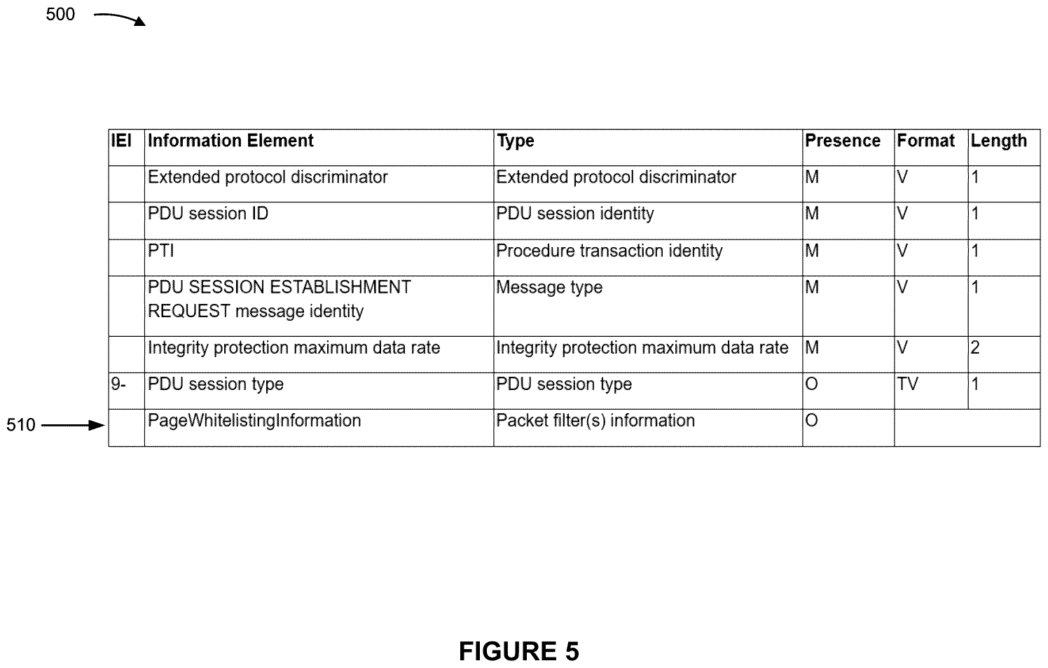

FIG. 5 is a diagram illustrating an example 500 associated with a PDU session establishment or modification request message that includes per-tuple network paging whitelisting information, in accordance with the present disclosure.

Example 500 shows various fields (for example, IEs) that may be present in a PDU session establishment or modification request message. As shown, an IE may have a corresponding information element identifier (IEI), type presence, format, or length. As shown by field 510, the PDU session establishment or modification request message may include per-tuple network paging whitelisting information, as discussed above in connection with the second operation 312 (FIG. 3). Thus, the field 510 may allow the UE 120 to add, modify, or remove the network-side whitelist.

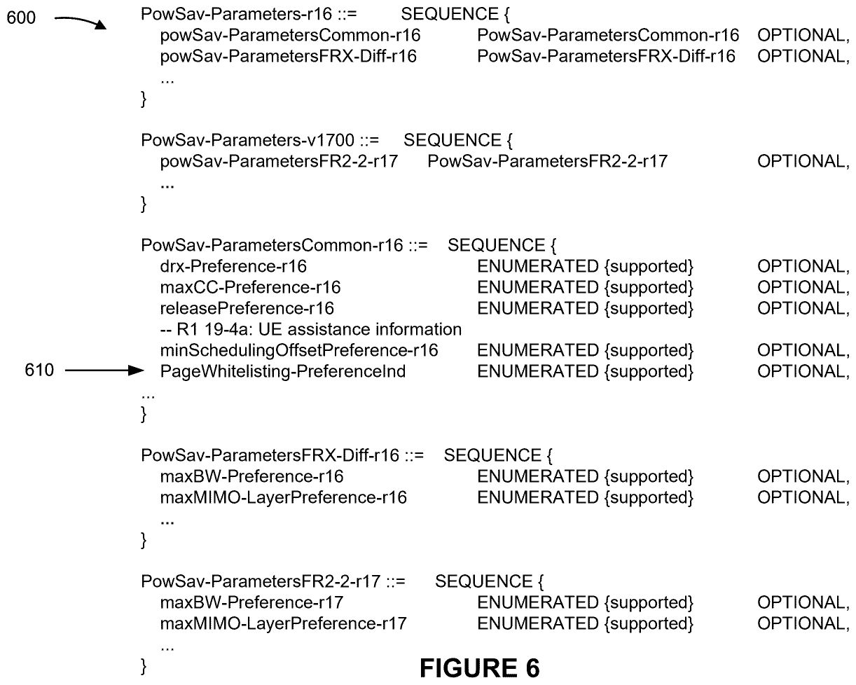

FIG. 6 is a diagram illustrating an example 600 associated with UE capability information indicating support for per-tuple network paging whitelisting, in accordance with the present disclosure.

Example 600 shows various fields that may be present in UE capability information (for example, a PowSav-Parameters Common IE in a UE-NR-Capability field). As shown by field 610, the UE capability information may include an indication (for example, a PageWhitelisting-PreferenceInd parameter) of a preference of the UE 120 for page whitelisting using UAI, as discussed above in connection with operation 402 (FIG. 4). Thus, the UE 120 may use the UE capability information to indicate whether the UE 120 supports indicating UE preferences for page whitelisting. Table 1 below provides further information regarding the PageWhitelisting-PreferenceInd parameter.

TABLE 1

| | | | Difference in | |
|---|---|---|---|---|
| | | | frequency | |
| | | | domain | |
| | | | duplexing | |
| | | | versus time | Difference |
| | | | domain | between FR1 |
| | | | duplexing | and FR2 |
| | | | (FDD-TDD | (FR1-FR2 |
| Definitions of Parameter | Per | M | DIFF) | DIFF) |
| PageWhitelisting-PreferenceInd | UE | No | No | No |
| may identify whether the UE | | | | |
| 120 supports an indication of | | | | |
| a UE preference for page | | | | |
| whitelisting in an RRC | | | | |
| connected mode (RRC_{—} | | | | |
| Connected), which may help to | | | | |
| conserve UE power while in an | | | | |
| RRC idle mode (RRC_IDLE) | | | | |

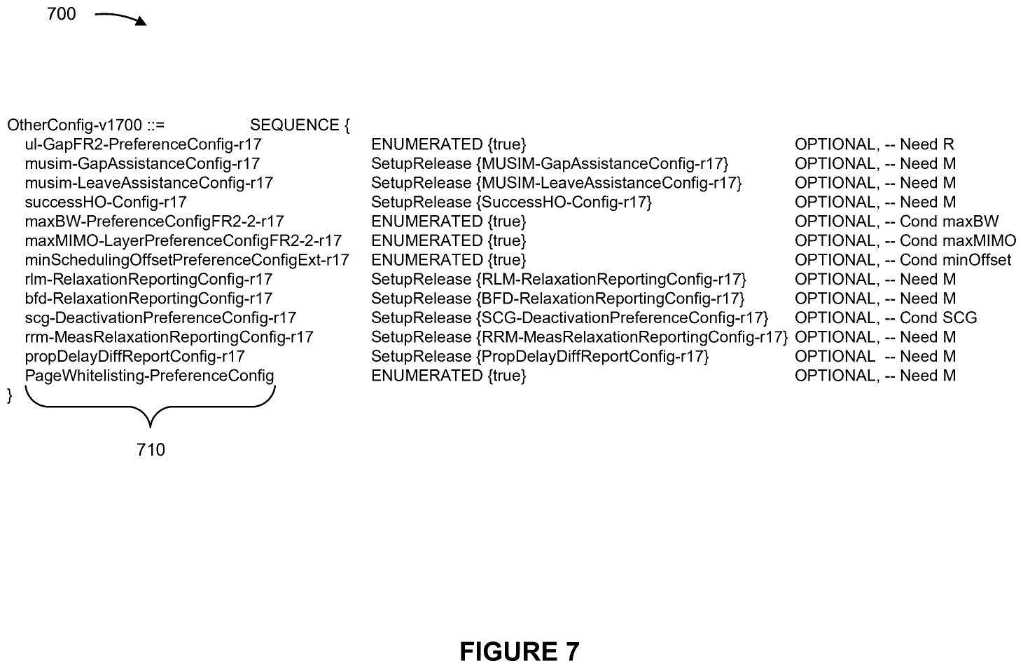

FIG. 7 is a diagram illustrating an example 700 associated with a per-tuple network paging whitelisting configuration, in accordance with the present disclosure.

Example 700 shows various fields that may be present in a per-tuple network paging whitelisting configuration (for example, a UE capability configuration). For example, as shown by field 710, the UE capability information may include a configuration (for example, a Page Whitelisting-PreferenceConfig field in an OtherConfig IE) that allows the network node 110 to indicate, to the UE 120, that the network supports accepting the per-tuple network paging whitelisting information, as discussed above in connection with operation 404 (FIG. 4).

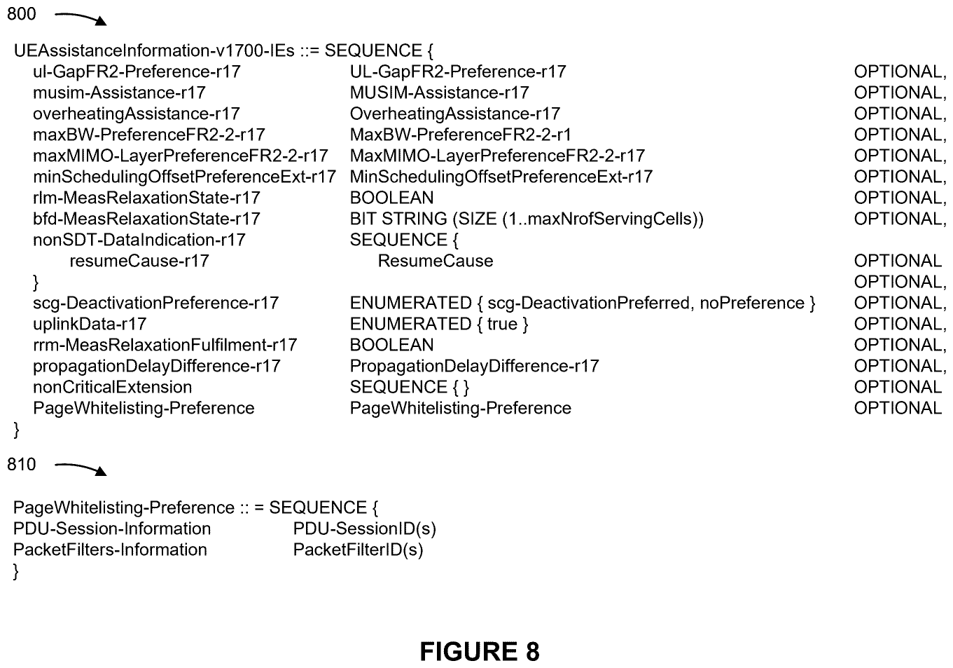

FIG. 8 is a diagram illustrating examples 800 and 810 associated with a per-tuple network paging whitelisting UAI, in accordance with the present disclosure.

Example 800 shows various fields that may be present in UAI (for example, a UAI IE). For example, the UAI may include per-tuple network paging whitelisting information (for example, a PageWhitelisting-Preference field) that allows the UE 120 to indicate a UE preference for page whitelisting. Example 810 shows IEs within the PageWhitelisting-Preference field, which may indicate the per-tuple network paging whitelisting information (for example, PDU session information or packet filter information, among other examples). Thus, the UE 120 may indicate the per-tuple network paging whitelisting information in the UAI), as discussed above in connection with operation 406 (FIG. 4A).

The per-tuple network paging whitelisting information may help to suppress unnecessary paging of the UE 120, thereby substantially reducing modem or CPU workload and/or prolonging the battery life. For example, modem or CPU workload and/or battery life may be improved for a vehicular UE 120 in a parked state, a single-USIM UE 120, or a vehicular UE 120 in a non-parked state and in a dual SIM, dual DSDA mode, among other examples. Furthermore, the per-tuple network paging whitelisting information, which may be negotiated by the SMF 304, allows for granular (rather than per-PDU-session) paging restrictions. For example, the per-tuple network paging whitelisting information may enable packet filters for granular page whitelisting within a PDU session. For example, packet filters of the network-side whitelist may allow certain paging messages that originate from whitelisted IP addresses of a PDU session and deny paging messages that originate from non-whitelisted IP addresses of the same PDU session.

The request to establish the network session including the per-tuple network paging whitelisting information may help to further conserve power at the UE 120. For example, the UE 120 may configure the network-side whitelist according to a remaining battery life of the UE 120.

The network node 110 receiving the per-tuple network paging whitelisting information from the server may help to improve a service (for example, an application) provided by the server for the UE 120. For example, the server may configure the network-side whitelist according to an importance of packets transmitted by the server.

FIG. 9 is a flowchart illustrating an example process 900 performed, for example, at a UE or an apparatus of a UE that supports per-tuple network paging whitelisting in accordance with the present disclosure. Example process 900 is an example where the apparatus or the UE (for example, UE 120) performs operations associated with per-tuple network paging whitelisting.

As shown in FIG. 9, in some aspects, process 900 may include transmitting a request to establish a network session (block 910). For example, the UE (such as by using communication manager 1106 or transmission component 1104, depicted in FIG. 11) may transmit a request to establish a network session, as described above.

As further shown in FIG. 9, in some aspects, process 900 may include receiving an indication of per-tuple network paging whitelisting information associated with the network session (block 920). For example, the UE (such as by using communication manager 1106 or reception component 1102, depicted in FIG. 11) may receive an indication of per-tuple network paging whitelisting information associated with the network session, as described above.

As further shown in FIG. 9, in some aspects, process 900 may include selectively receiving a paging message in accordance with the per-tuple network paging whitelisting information (block 930). For example, the UE (such as by using communication manager 1106 or reception component 1102, depicted in FIG. 11) may selectively receive a paging message in accordance with the per-tuple network paging whitelisting information, as described above.

Process 900 may include additional aspects, such as any single aspect or any combination of aspects described below or in connection with one or more other processes described elsewhere herein.

In a first additional aspect, the per-tuple network paging whitelisting information includes one or more of a filter identifier, a packet filter, an allowed page type, or an allowed packet type.

In a second additional aspect, alone or in combination with the first aspect, the packet filter includes one or more of a source IP address, a destination IP address, a source port, a destination port, or a protocol.

In a third additional aspect, alone or in combination with one or more of the first and second aspects, the request to establish the network session includes the per-tuple network paging whitelisting information.

In a fourth additional aspect, alone or in combination with one or more of the first through third aspects, the per-tuple network paging whitelisting information includes a whitelisted IP address.

In a fifth additional aspect, alone or in combination with one or more of the first through fourth aspects, process 900 includes transmitting a network session modification message that includes updated per-tuple network paging whitelisting information.

In a sixth additional aspect, alone or in combination with one or more of the first through fifth aspects, process 900 includes transmitting UE assistance information including the per-tuple network paging whitelisting information.

In a seventh additional aspect, alone or in combination with one or more of the first through sixth aspects, the per-tuple network paging whitelisting information includes a whitelisted IP address.

In an eighth additional aspect, alone or in combination with one or more of the first through seventh aspects, process 900 includes transmitting UE capability information indicating support for per-tuple network paging whitelisting.

In a ninth additional aspect, alone or in combination with one or more of the first through eighth aspects, process 900 includes receiving a per-tuple network paging whitelisting configuration in accordance with the UE capability information.

In a tenth additional aspect, alone or in combination with one or more of the first through ninth aspects, process 900 includes transmitting UE assistance information including updated per-tuple network paging whitelisting information.

Although FIG. 9 shows example blocks of process 900, in some aspects, process 900 may include additional blocks, fewer blocks, different blocks, or differently arranged blocks than those depicted in FIG. 9. Additionally or alternatively, two or more of the blocks of process 900 may be performed in parallel.

FIG. 10 is a flowchart illustrating an example process 1000 performed, for example, at a network node or an apparatus of a network node that supports per-tuple network paging whitelisting in accordance with the present disclosure. Example process 1000 is an example where the apparatus or the network node (for example, network node 110) performs operations associated with per-tuple network paging whitelisting.

As shown in FIG. 10, in some aspects, process 1000 may include receiving a request to establish a network session (block 1010). For example, the network node (such as by using communication manager 1206 or reception component 1202, depicted in FIG. 12) may receive a request to establish a network session, as described above.

As further shown in FIG. 10, in some aspects, process 1000 may include transmitting an indication of per-tuple network paging whitelisting information associated with the network session (block 1020). For example, the network node (such as by using communication manager 1206 or transmission component 1204, depicted in FIG. 12) may transmit an indication of per-tuple network paging whitelisting information associated with the network session, as described above.

As further shown in FIG. 10, in some aspects, process 1000 may include selectively transmitting a paging message in accordance with the per-tuple network paging whitelisting information (block 1030). For example, the network node (such as by using communication manager 1206 or transmission component 1204, depicted in FIG. 12) may selectively transmit a paging message in accordance with the per-tuple network paging whitelisting information, as described above.

Process 1000 may include additional aspects, such as any single aspect or any combination of aspects described below or in connection with one or more other processes described elsewhere herein.

In a first additional aspect, the per-tuple network paging whitelisting information includes one or more of a filter identifier, a packet filter, an allowed page type, or an allowed packet type.

In a second additional aspect, alone or in combination with the first aspect, the packet filter includes one or more of a source IP address, a destination IP address, a source port, a destination port, or a protocol.

In a third additional aspect, alone or in combination with one or more of the first and second aspects, the request to establish the network session includes the per-tuple network paging whitelisting information.

In a fourth additional aspect, alone or in combination with one or more of the first through third aspects, the per-tuple network paging whitelisting information includes a whitelisted IP address.

In a fifth additional aspect, alone or in combination with one or more of the first through fourth aspects, process 1000 includes transmitting a network session establishment or modification request that includes the per-tuple network paging whitelisting information.

In a sixth additional aspect, alone or in combination with one or more of the first through fifth aspects, process 1000 includes receiving a request indicating the per-tuple network paging whitelisting information.

In a seventh additional aspect, alone or in combination with one or more of the first through sixth aspects, process 1000 includes receiving a network session modification message that includes updated per-tuple network paging whitelisting information.

In an eighth additional aspect, alone or in combination with one or more of the first through seventh aspects, process 1000 includes receiving the per-tuple network paging whitelisting information from a server.

In a ninth additional aspect, alone or in combination with one or more of the first through eighth aspects, process 1000 includes receiving UE assistance information including the per-tuple network paging whitelisting information.

In a tenth additional aspect, alone or in combination with one or more of the first through ninth aspects, the per-tuple network paging whitelisting information includes a whitelisted IP address.

In an eleventh additional aspect, alone or in combination with one or more of the first through tenth aspects, process 1000 includes receiving UE capability information indicating support for per-tuple network paging whitelisting.

In a twelfth additional aspect, alone or in combination with one or more of the first through eleventh aspects, process 1000 includes transmitting a per-tuple network paging whitelisting configuration in accordance with the UE capability information.

In a thirteenth additional aspect, alone or in combination with one or more of the first through twelfth aspects, process 1000 includes transmitting a request indicating the per-tuple network paging whitelisting information in accordance with the UE assistance information.

In a fourteenth additional aspect, alone or in combination with one or more of the first through thirteenth aspects, process 1000 includes receiving a request indicating the per-tuple network paging whitelisting information.

In a fifteenth additional aspect, alone or in combination with one or more of the first through fourteenth aspects, process 1000 includes receiving UE assistance information including updated per-tuple network paging whitelisting information.

Although FIG. 10 shows example blocks of process 1000, in some aspects, process 1000 may include additional blocks, fewer blocks, different blocks, or differently arranged blocks than those depicted in FIG. 10. Additionally or alternatively, two or more of the blocks of process 1000 may be performed in parallel.

FIG. 11 is a diagram of an example apparatus 1100 for wireless communication that supports per-tuple network paging whitelisting in accordance with the present disclosure. The apparatus 1100 may be a UE, or a UE may include the apparatus 1100. In some aspects, the apparatus 1100 includes a reception component 1102, a transmission component 1104, and a communication manager 1106, which may be in communication with one another (for example, via one or more buses). As shown, the apparatus 1100 may communicate with another apparatus 1108 (such as a UE 120, a network node 110, or another wireless communication device) using the reception component 1102 and the transmission component 1104. The communication manager 1106 may be included in, or implemented via, a processing system (for example, the processing system 140). In some aspects, the communication manager 1106 is the communication manager 150.

In some aspects, the apparatus 1100 may be configured to and/or operable to perform one or more operations described herein in connection with FIGS. 2-8. Additionally or alternatively, the apparatus 1100 may be configured to and/or operable to perform one or more processes described herein, such as process 900 of FIG. 9.

The reception component 1102 may receive communications, such as reference signals, control information, and/or data communications, from the apparatus 1108. The reception component 1102 may provide received communications to one or more other components of the apparatus 1100, such as the communication manager 1106. In some aspects, the reception component 1102 may perform signal processing on the received communications, and may provide the processed signals to the one or more other components in a similar manner as described above in connection with FIG. 1. In some aspects, the reception component 1102 may include one or more components of the UE described above in connection with FIG. 1, such as a radio, one or more RF chains, one or more transceivers, or one or more modems, each of which may in turn be coupled with one or more antennas of the UE.

The transmission component 1104 may transmit communications, such as reference signals, control information, and/or data communications, to the apparatus 1108. In some aspects, the communication manager 1106 may generate communications and may transmit the generated communications to the transmission component 1104 for transmission to the apparatus 1108. In some aspects, the transmission component 1104 may perform signal processing on the generated communications, and may transmit the processed signals to the apparatus 1108 in a similar manner as described above in connection with FIG. 1. In some aspects, the transmission component 1104 may include one or more components of the UE described above in connection with FIG. 1, such as a radio, one or more RF chains, one or more transceivers, or one or more modems, each of which may in turn be coupled with one or more antennas of the UE. In some aspects, the transmission component 1104 may be co-located with the reception component 1102.

The communication manager 1106 may transmit or may cause the transmission component 1104 to transmit a request to establish a network session. The communication manager 1106 may receive or may cause the reception component 1102 to receive an indication of per-tuple network paging whitelisting information associated with the network session. The communication manager 1106 may receive or may cause the reception component 1102 to selectively receive a paging message in accordance with the per-tuple network paging whitelisting information. In some aspects, the communication manager 1106 may perform one or more operations described elsewhere herein as being performed by one or more components of the communication manager 1106.

The transmission component 1104 may transmit a request to establish a network session. The reception component 1102 may receive an indication of per-tuple network paging whitelisting information associated with the network session. The reception component 1102 may selectively receive a paging message in accordance with the per-tuple network paging whitelisting information.

In some aspects, the transmission component 1104 may transmit a network session modification message that includes updated per-tuple network paging whitelisting information. In some aspects, the transmission component 1104 may transmit UE assistance information including the per-tuple network paging whitelisting information. In some aspects, the transmission component 1104 may transmit UE capability information indicating support for per-tuple network paging whitelisting. In some aspects, the transmission component 1104 may transmit UE assistance information including updated per-tuple network paging whitelisting information.

In some aspects, the reception component 1102 may receive a per-tuple network paging whitelisting configuration in accordance with the UE capability information.

The quantity and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally or alternatively, a set of (one or more) components shown in FIG. 11 may perform one or more functions described as being performed by another set of components shown in FIG. 11.

FIG. 12 is a diagram of an example apparatus 1200 for wireless communication that supports per-tuple network paging whitelisting in accordance with the present disclosure. The apparatus 1200 may be a network node, or a network node may include the apparatus 1200. In some aspects, the apparatus 1200 includes a reception component 1202, a transmission component 1204, and a communication manager 1206, which may be in communication with one another (for example, via one or more buses). As shown, the apparatus 1200 may communicate with another apparatus 1208 (such as a UE 120, a network node 110, or another wireless communication device) using the reception component 1202 and the transmission component 1204. The communication manager 1206 may be included in, or implemented via, a processing system (for example, the processing system 145). In some aspects, the communication manager 1206 is the communication manager 155.

In some aspects, the apparatus 1200 may be configured to and/or operable to perform one or more operations described herein in connection with FIGS. 2-8. Additionally or alternatively, the apparatus 1200 may be configured to and/or operable to perform one or more processes described herein, such as process 1000 of FIG. 10.

The reception component 1202 may receive communications, such as reference signals, control information, and/or data communications, from the apparatus 1208. The reception component 1202 may provide received communications to one or more other components of the apparatus 1200, such as the communication manager 1206. In some aspects, the reception component 1202 may perform signal processing on the received communications, and may provide the processed signals to the one or more other components in a similar manner as described above in connection with FIG. 1. In some aspects, the reception component 1202 may include one or more components of the network node described above in connection with FIG. 1, such as a radio, one or more RF chains, one or more transceivers, or one or more modems, each of which may in turn be coupled with one or more antennas of the network node.

The transmission component 1204 may transmit communications, such as reference signals, control information, and/or data communications, to the apparatus 1208. In some aspects, the communication manager 1206 may generate communications and may transmit the generated communications to the transmission component 1204 for transmission to the apparatus 1208. In some aspects, the transmission component 1204 may perform signal processing on the generated communications, and may transmit the processed signals to the apparatus 1208 in a similar manner as described above in connection with FIG. 1. In some aspects, the transmission component 1204 may include one or more components of the network node described above in connection with FIG. 1, such as a radio, one or more RF chains, one or more transceivers, or one or more modems, each of which may in turn be coupled with one or more antennas of the network node. In some aspects, the transmission component 1204 may be co-located with the reception component 1202.

The communication manager 1206 may receive or may cause the reception component 1202 to receive a request to establish a network session. The communication manager 1206 may transmit or may cause the transmission component 1204 to transmit an indication of per-tuple network paging whitelisting information associated with the network session. The communication manager 1206 may transmit or may cause the transmission component 1204 to selectively transmit a paging message in accordance with the per-tuple network paging whitelisting information. In some aspects, the communication manager 1206 may perform one or more operations described elsewhere herein as being performed by one or more components of the communication manager 1206.

The reception component 1202 may receive a request to establish a network session. The transmission component 1204 may transmit an indication of per-tuple network paging whitelisting information associated with the network session. The transmission component 1204 may selectively transmit a paging message in accordance with the per-tuple network paging whitelisting information.

In some aspects, the reception component 1202 may receive a request indicating the per-tuple network paging whitelisting information. In some aspects, the reception component 1202 may receive a network session modification message that includes updated per-tuple network paging whitelisting information. In some aspects, the reception component 1202 may receive the per-tuple network paging whitelisting information from a server. In some aspects, the reception component 1202 may receive UE assistance information including the per-tuple network paging whitelisting information. In some aspects, the reception component 1202 may receive UE capability information indicating support for per-tuple network paging whitelisting. In some aspects, the reception component 1202 may receive a request indicating the per-tuple network paging whitelisting information. In some aspects, the reception component 1202 may receive UE assistance information including updated per-tuple network paging whitelisting information.

In some aspects, the transmission component 1204 may transmit a network session establishment or modification request that includes the per-tuple network paging whitelisting information. In some aspects, the transmission component 1204 may transmit a per-tuple network paging whitelisting configuration in accordance with the UE capability information. In some aspects, the transmission component 1204 may transmit a request indicating the per-tuple network paging whitelisting information in accordance with the UE assistance information.

The quantity and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed at a user equipment (UE), comprising: transmitting a request to establish a network session; receiving an indication of per-tuple network paging whitelisting information associated with the network session; and selectively receiving a paging message in accordance with the per-tuple network paging whitelisting information.

Aspect 2: The method of Aspect 1, wherein the per-tuple network paging whitelisting information includes one or more of a filter identifier, a packet filter, an allowed page type, or an allowed packet type.

Aspect 3: The method of Aspect 2, wherein the packet filter includes one or more of a source internet protocol (IP) address, a destination IP address, a source port, a destination port, or a protocol.

Aspect 4: The method of any of Aspects 1-3, wherein the request to establish the network session includes the per-tuple network paging whitelisting information.

Aspect 5: The method of Aspect 4, wherein the per-tuple network paging whitelisting information includes a whitelisted internet protocol (IP) address.

Aspect 6: The method of Aspect 4, further comprising: transmitting a network session modification message that includes updated per-tuple network paging whitelisting information.

Aspect 7: The method of any of Aspects 1-6, further comprising: transmitting UE assistance information including the per-tuple network paging whitelisting information.

Aspect 8: The method of Aspect 7, wherein the per-tuple network paging whitelisting information includes a whitelisted internet protocol (IP) address.

Aspect 9: The method of Aspect 7, further comprising: transmitting UE capability information indicating support for per-tuple network paging whitelisting.

Aspect 10: The method of Aspect 9, further comprising: receiving a per-tuple network paging whitelisting configuration in accordance with the UE capability information.

Aspect 11: The method of Aspect 7, further comprising: transmitting UE assistance information including updated per-tuple network paging whitelisting information.

Aspect 12: A method of wireless communication performed at a network node, comprising: receiving a request to establish a network session; transmitting an indication of per-tuple network paging whitelisting information associated with the network session; and selectively transmitting a paging message in accordance with the per-tuple network paging whitelisting information.

Aspect 13: The method of Aspect 12, wherein the per-tuple network paging whitelisting information includes one or more of a filter identifier, a packet filter, an allowed page type, or an allowed packet type.

Aspect 14: The method of Aspect 13, wherein the packet filter includes one or more of a source internet protocol (IP) address, a destination IP address, a source port, a destination port, or a protocol.

Aspect 15: The method of any of Aspects 12-14, wherein the request to establish the network session includes the per-tuple network paging whitelisting information.

Aspect 16: The method of Aspect 15, wherein the per-tuple network paging whitelisting information includes a whitelisted internet protocol (IP) address.

Aspect 17: The method of Aspect 15, further comprising: transmitting a network session establishment or modification request that includes the per-tuple network paging whitelisting information.

Aspect 18: The method of Aspect 15, further comprising: receiving a request indicating the per-tuple network paging whitelisting information.

Aspect 19: The method of Aspect 15, further comprising: receiving a network session modification message that includes updated per-tuple network paging whitelisting information.

Aspect 20: The method of any of Aspects 12-19, further comprising: receiving the per-tuple network paging whitelisting information from a server.

Aspect 21: The method of any of Aspects 12-20, further comprising: receiving user equipment (UE) assistance information including the per-tuple network paging whitelisting information.

Aspect 22: The method of Aspect 21, wherein the per-tuple network paging whitelisting information includes a whitelisted internet protocol (IP) address.

Aspect 23: The method of Aspect 21, further comprising: receiving user equipment (UE) capability information indicating support for per-tuple network paging whitelisting.

Aspect 24: The method of Aspect 23, further comprising: transmitting a per-tuple network paging whitelisting configuration in accordance with the UE capability information.

Aspect 25: The method of Aspect 21, further comprising: transmitting a request indicating the per-tuple network paging whitelisting information in accordance with the UE assistance information.

Aspect 26: The method of Aspect 21, further comprising: receiving a request indicating the per-tuple network paging whitelisting information.

Aspect 27: The method of Aspect 21, further comprising: receiving UE assistance information including updated per-tuple network paging whitelisting information.

Aspect 28: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-27.

Aspect 29: An apparatus for wireless communication at a device, the apparatus comprising one or more memories and one or more processors coupled to the one or more memories, the one or more processors configured to cause the device to perform the method of one or more of Aspects 1-27.

Aspect 30: An apparatus for wireless communication, the apparatus comprising at least one means for performing the method of one or more of Aspects 1-27.

Aspect 31: A non-transitory computer-readable medium storing code for wireless communication, the code comprising instructions executable by one or more processors to perform the method of one or more of Aspects 1-27.

Aspect 32: A non-transitory computer-readable medium storing a set of instructions for wireless communication, the set of instructions comprising one or more instructions that, when executed by one or more processors of a device, cause the device to perform the method of one or more of Aspects 1-27.

Aspect 33: A device for wireless communication, the device comprising a processing system that includes one or more processors and one or more memories coupled with the one or more processors, the processing system configured to cause the device to perform the method of one or more of Aspects 1-27.

Aspect 34: An apparatus for wireless communication at a device, the apparatus comprising one or more memories and one or more processors coupled to the one or more memories, the one or more processors individually or collectively configured to cause the device to perform the method of one or more of Aspects 1-27.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories storing processor-executable code; and
one or more processors coupled with the one or more memories, at least one processor of the one or more processors configured to cause the UE to:
transmit a request to establish a network session;
receive an indication of per-tuple network paging whitelisting information associated with the network session; and
selectively receive a paging message in accordance with the per-tuple network paging whitelisting information.

2. The apparatus of claim 1, wherein the per-tuple network paging whitelisting information includes one or more of a filter identifier, a packet filter, an allowed page type, or an allowed packet type.

3. The apparatus of claim 2, wherein the packet filter includes one or more of a source internet protocol (IP) address, a destination IP address, a source port, a destination port, or a protocol.

4. The apparatus of claim 1, wherein the request to establish the network session includes the per-tuple network paging whitelisting information.

5. The apparatus of claim 4, wherein the per-tuple network paging whitelisting information includes a whitelisted internet protocol (IP) address.

6. The apparatus of claim 4, wherein at least one processor of the one or more processors is configured to cause the UE to:
transmit a network session modification message that includes updated per-tuple network paging whitelisting information.

7. A method of wireless communication performed at a user equipment (UE), comprising:
transmitting a request to establish a network session;
receiving an indication of per-tuple network paging whitelisting information associated with the network session; and
selectively receiving a paging message in accordance with the per-tuple network paging whitelisting information.

8. The method of claim 7, further comprising:
transmitting UE assistance information including the per-tuple network paging whitelisting information.

9. The method of claim 8, wherein the per-tuple network paging whitelisting information includes a whitelisted internet protocol (IP) address.

10. The method of claim 8, further comprising:
transmitting UE capability information indicating support for per-tuple network paging whitelisting.

11. The method of claim 10, further comprising:
receiving a per-tuple network paging whitelisting configuration in accordance with the UE capability information.

12. The method of claim 8, further comprising:
transmitting UE assistance information including updated per-tuple network paging whitelisting information.

13. An apparatus for wireless communication at a network node, comprising:
one or more memories storing processor-executable code; and
one or more processors coupled with the one or more memories, at least one processor of the one or more processors configured to cause the network node to:
receive a request to establish a network session;
transmit an indication of per-tuple network paging whitelisting information associated with the network session; and
selectively transmit a paging message in accordance with the per-tuple network paging whitelisting information.

14. The apparatus of claim 13, wherein the request to establish the network session includes the per-tuple network paging whitelisting information.

15. The apparatus of claim 14, wherein at least one processor of the one or more processors is configured to cause the network node to:
transmit a network session establishment or modification request that includes the per-tuple network paging whitelisting information.

16. The apparatus of claim 14, wherein at least one processor of the one or more processors is configured to cause the network node to:
receive a request indicating the per-tuple network paging whitelisting information.

17. The apparatus of claim 13, wherein at least one processor of the one or more processors is configured to cause the network node to:
receive the per-tuple network paging whitelisting information from a server.

18. The apparatus of claim 13, wherein at least one processor of the one or more processors is configured to cause the network node to:
receive user equipment (UE) assistance information including the per-tuple network paging whitelisting information.

19. The apparatus of claim 18, wherein at least one processor of the one or more processors is configured to cause the network node to:
transmit a request indicating the per-tuple network paging whitelisting information in accordance with the UE assistance information.

20. The apparatus of claim 18, wherein at least one processor of the one or more processors is configured to cause the network node to:
receive a request indicating the per-tuple network paging whitelisting information.
